(19) United States
(12) Patent Application Publication
(10) Pub. No.: US 2008/0153691 A1
(43) Pub. Date: Jun. 26, 2008

(54) Method of Making Catalyst For Carbon Nanotubes and Carbon Nanofibers and Catalyst For Carbon Nanotubes and Nanofibers Thereof

(76) Inventors: Won-Sub Jung, Pusan City (KR); Sung-Sil Jung, Gyeongsangbuk-Do (KR); Heung-Won Kang, Gyeongsangbuk-Do (KR); Dae-Yeol Lee, Gyeongsangbuk-Do (KR)

Correspondence Address: IPLA P.A., 3580 WILSHIRE BLVD., 17TH FLOOR, LOS ANGELES, CA, 90010, US

(21) Appl. No.: 10/595,284

(22) PCT Filed: Oct. 5, 2004
(86) PCT No.: PCT/KR04/02546

§ 371 Date: Apr. 4, 2006

(30) Foreign Application Priority Data
Oct. 6, 2003 (KR) 10-2003-0069331

(51) Int. Cl. B01J 21/08; B01J 23/00; B01J 23/755; B01J 23/75; B01J 23/745; B01J 21/10; B01J 21/04; B01J 23/28; B01J 23/26; B01J 23/76

(52) U.S. Cl. 502/240; 502/300; 502/321; 502/338; 502/337; 502/325; 502/345; 502/355; 502/319; 502/177; 502/216; 502/200; 502/340

(57) ABSTRACT

The present invention relates to a method of making a catalyst for carbon nanotubes and nanofibers, comprising heating oxygen compound of transition metal in oxidative ambient at a temperature of 800° C. through 1,5000 C to be transformed into an agglomerated transition metal oxide; and powdering the agglomerated transition metal oxide into a minute particle. Thus, the present invention provides a catalyst for carbon nanotubes and carbon nanofibers, and a method of making the same, in which production cost is reduced and it is possible to safekeep for a long time.

### FIELD OF THE INVENTION

The present invention relates to a catalyst for carbon nanotubes and nanofibers and a method of making the same.

### BACKGROUND ART

Carbon nanowires such as carbon nanotubes and carbon nanofibers are new utility materials excellent in electrical and mechanical properties. Generally, as a method of making the carbon nanowires, there are an arc-discharge method, a laser evaporization method, a vapor phase growth method, an electrolysis method, etc. The vapor phase growth method classified into a method using a substrate and a method using no-substrate, wherein the method of directly supplying a reaction gas and a catalyst without the substrate into a reactor is prefer to massively synthesize the carbon nanowires.

The catalyst used in the vapor phase growth method for the carbon nanowires is made by (1) oxidation and reduction (precipitation/coprecipitation) from various metal salts using ammonium bicarbonate, P. E. Anderson et. al., J. Mater. Res., 14(7) 2912 (1999); (2) evaporation/deposition of metallocene in a reducing ambient; (3) spraying/drying of pure metal dispersed in a solvent; (4) vacuum deposition of transition metal particles on the substrate containing alumina or silica; etc. In the case of (2) and (3), there is needed a relatively expensive precursor. In the case of (1), the catalyst is directly made, so that a manufacturing process is complicated, an intermediate product causes pollution, and it is difficult to safekeep the catalyst for a long time because the catalyst is likely to be oxidized again. In the case of (4), production cost of the catalyst is relatively high, and it is difficult to massively produce the catalyst.

### DISCLOSURE OF INVENTION

Accordingly, it is an aspect of the present invention to provide a catalyst for carbon nanotubes and carbon nanofibers, and a method of making the same, in which production cost is reduced and it is possible to safekeep for a long time.

The foregoing and other aspects of the present invention are achieved by providing a method of making a catalyst for carbon nanotubes and nanofibers, comprising heating oxygen compound of transition metal in oxidative ambient at a temperature of 800° C. through 1,5000° C. to be transformed into an agglomerated transition metal oxide; and powdering the agglomerated transition metal oxide into a minute particle.

According to another aspect of the present invention, the transition metal includes one or more selected from a group consisting of nickel (Ni), cobalt (Co), iron (Fe), molybdenum (Mo), and chrome (Cr).

According to another aspect of the present invention, the oxidation compound of the transition metal includes one or more selected from a group consisting of transition metal oxide, hydroxide, carbide, sulfide and nitride.

According to another aspect of the present invention, the agglomerated transition metal oxide is powdered to have an average particle size of 500 μm or below.

According to another aspect of the present invention, the oxygen compound of the transition metal includes oxygen compound of copper.

According to another aspect of the present invention, the oxygen compound of copper ranges from 10% to 50% weight with regard to 100% weight of the transition metal oxide.

According to another aspect of the present invention, the oxygen compound of the transition metal is heated at a temperature of 800° C. through 1,000° C.

According to another aspect of the present invention, the oxygen compound of the transition metal is heated together with a support material selected from a group consisting of silica, alumina and magnesia.

According to another aspect of the present invention, the oxygen compound of the transition metal is heated at a temperature of 1,000° C. through 1,400° C.

The foregoing and other aspects of the present invention are achieved by providing a catalyst for carbon nanotubes and nanofibers, which has an average particle size of 500 μm or below and in which transition metal oxide and copper oxide are sintered.

The foregoing and other aspects of the present invention are achieved by providing a catalyst for carbon nanotubes and nanofibers, which has an average particle size of 500 μm or below and in which transition metal oxide and a support material selected from a group consisting of silica, alumina and magnesia are sintered.

According to another aspect of the present invention, the transition metal includes one or more selected from a group consisting of nickel (Ni), cobalt (Co), iron (Fe), molybdenum (Mo), and chrome (Cr).

### MODES FOR CARRYING OUT THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

According to an embodiment of the present invention, a catalyst made including a support material is mostly employed in manufacturing a carbon nanotube. On the other hand, a catalyst made including oxygen compound of copper without the support material is mostly employed in manufacturing a carbon nanofiber.

Hereinbelow, the catalyst for the carbon nanotube and the catalyst for the carbon nanofiber will be described separately.

First, a method of making the catalyst for the carbon nanotube includes the following three steps.

A first step: oxygen compound powder of one or more kinds of transition metal and support material powder of one or more selected among silica, alumina and magnesia are uniformly mixed.

A second step: the mixture is annealed in an oxidative ambient.

A third step: the annealed and agglomerated mixture is cooled and powdered by the micron scale.

In the case where the carbon nanotube is manufactured by a vapor phase growth method, and hydrogen gas in addition to carbon source gas is used as carrier gas, there is not needed for reducing metal oxide into metal which is unstable in the atmosphere because reduction and carbon deposition reactions are performed at the same time by the catalyst according to an embodiment of the present invention. Likewise, this is applied to the manufacturer of the carbon nanofiber.

In the first step, there is not limit to the particle size of the foregoing powders. However, the powder preferably has the micro scale size because the powder is deteriorated in reactivity, uniformity, and heat transfer property according as the particle size thereof is increased. The oxygen compound of the transition metal includes the oxygen compounds of nickel, cobalt, iron, molybdenum and chrome, that is, includes one or more selected among oxide, nitride, carbide, sulfide and hydroxide. The support material includes one or more selected among silica, alumina and magnesia. To uniformize distribution of the catalyst, the oxygen compound of the transition metal and the support material are sufficiently mixed in a drum mixer or the like.

In the second step, the mixture is treated to have a briquette formation, or is being put in a crucible, and then heated at a temperature of 800˜1,500° C. in the oxidative ambient by inserting it in an electric furnace. The oxidative ambient comprises atmosphere ambient. Preferably, the oxidative ambient includes the atmosphere. At this time, a temperature of 1,000˜1,400° C. is preferable. Further, a temperature of 1,200° C.˜1,300° C. is more preferable. The heated mixture is calcined/annealed, so that the oxygen compound of the transition metal is transformed into a transition metal oxide. While the oxygen compound of the transition metal is transformed into the transition metal oxide, the transition metal oxide and the support material are sintered, so that the transition metal oxide and the support material are formatively mixed, thereby allowing a formative interface to be in a deposition state. If the mixture is heated at a temperature of 800° C. or below, it takes so long time to calcine/anneal the mixture and it is difficult to get a compact mixture formation. If the mixture is heated at a temperature of 1,500° C. or more, it is softening-fused or coarsened. Meanwhile, a heating time is related to the amount of the mixture inserted in the electric furnace. Preferably, the mixture is sufficiently heated until the whole mixture formation is uniform. In this case, the content of the transition metal oxide shows catalyst performance in a broad fraction of a whole mixture weight, and preferably ranges from 5% to 95%. If the content of the transition metal oxide is beyond the range from 5% to 95%, a yield is so low that it is not practical. Through the second step, the mixture is sintered to have a agglomerated formation.

In the third step, the agglomerated mixture is powdered by the micron scale. Preferably, the agglomerated mixture is cooled before being powdered.

On the other hand, a method of making the catalyst for the carbone nanofiber includes the following three steps.

A first step: there are provided oxygen compound of one or more kinds of the transition metal. Preferably, the oxygen compound of copper is provided and mixed with the provided oxygen compound of the transition metal.

A second step: the mixture is annealed in the oxidative ambient.

A third step: the annealed and agglomerated mixture is cooled and powdered by the micron scale.

Contrary to the catalyst for the carbon nanotube, there is not needed the support material. Substitutively, the provided oxygen compound of the transition metal is preferably sintered together with the oxygen compound of copper or the oxygen compound of other kinds of transition metal, thereby being formatively mixed. Further, in the second step, the mixture is annealed at a temperature of 800˜1,000° C. Here, a heating time is in proportion to the amount of the mixture. Preferably, the mixture is sufficiently heated until the whole mixture formation is uniform. Then, the heated mixture is calcined/annealed, so that the oxygen compound of the transition metal and the oxygen compound of copper are transformed into a transition metal oxide and a copper oxide. While the oxygen compound of the transition metal and the oxygen compound of copper is transformed into the transition metal oxide and the copper oxide, the transition metal oxide and the copper oxide are sintered, so that the transition metal oxide and the copper oxide are formatively mixed, thereby allowing a formative interface to be in a deposition state. In the case of using the oxygen compound of copper, the content of the copper oxide shows catalyst performance in a broad content range, and preferably ranges from 10% to 50% weight with regard to 100% weight of the transition metal oxide.

A carbon deposition test is performed using the catalyst powder made by the foregoing process. Test results are good. Hereinbelow, the present invention will be described in more detail through the following embodiments, but is not limited to.

### EMBODIMENT 1

### Fe₂O₃—Al₂O₃ Catalyst

Hematite (Fe₂O₃) powder and alumina (Al₂O₃) powder are mixed by a weight ratio of 1:1 in the drum mixer for three hours. The mixed powder of 10 g is put in an alumina container and then heated in the atmosphere at a temperature of 1,300° C. in a box-type electric furnace for two hours. Then, the sintered mixture is cooled in the furnace. The agglomerated mixture is taken out from the electric furnace and powdered by a micron meter of 100 or below.

This powder of 0.3 g is put in an alumina boat, and then put in a pipe-type furnace mounted with a quartz tube a diameter of 60 mm. Then, the powder of 0.3 g is heated in a nitrogen ambient at a temperature of 650° C., is treated with reduction and carbon depositing reaction for 40 minutes in the state that nitrogen is substituted by mixed gas of 0.11/min hydrogen and 0.11/min ethylene, and is cooled to have a normal room temperature in the state that the mixed gas is substituted by nitrogen. After the cooling operation, a black material looking like the deposited carbon is observed by a transmission electron microscope. In result, a carbon nanotube of a hollow shape having an average diameter of 10˜50 nm is observed.

Besides, in the cases where catalysts are made by the same method as used in the first embodiment, using Fe₂O₃—MgO in a weight ratio of 1:1, using Fe₂O₃—SiO₂ in a weight ratio of 1:1, using Fe₂O₃—SiO₂—MgO in a weight ratio of 1:0.5:0.5, using Fe₂O₃—SiO₂—MgO—Al₂O₃ in a weight ratio of 1:0.5:0.5:0.5, using NiO—MgO in a weight ratio of 1:1, using CoO—SiO₂ in a weight ratio of 1:1, using Fe₂O₃—NiO—Al₂O₃ in a weight ratio of 1:1:1, and using Fe₂O₃—NiO—CoO—Al₂O₃—SiO₂—MgO in a weight ratio of 1:1:1:1:1:1, respectively, carbon nanotubes of a hollow shape having an average diameter of 10˜50 nm are observed as results of the carbon depositing reaction, like the first embodiment.

### EMBODIMENT 2

### Fe₂O₃—NiO Catalyst

Hematite (Fe₂O₃) powder and nickel oxide (NiO) powder are mixed by a weight ratio of 1:1 in the drum mixer for three hours. The mixed powder of 10 g is put in an alumina container and then heated in the atmosphere at a temperature of 900° C. in the box-type electric furnace for two hours. Then, the sintered mixture is cooled in the furnace. The sintered mixture is taken out from the electric furnace and powdered by an average micron meter of 100 or below.

This powder of 0.3 g is put in the alumina boat, and then put in the pipe-type furnace mounted with the quartz tube having a diameter of 60 mm. Then, the powder of 0.3 g is heated in the nitrogen ambient at a temperature of 550° C., is treated with reduction and carbon depositing reaction for 40 minutes in the state that nitrogen is substituted by mixed gas of 1 l/min hydrogen and 0.2 l/min acetylene, and is cooled to have a normal room temperature in the state that the mixed gas is substituted by nitrogen. After the cooling operation, a black material looking like the deposited carbon is observed by the transmission electron microscope. In result, a carbon nanofiber of a solid shape having an average diameter of 200 nm is observed.

### EMBODIMENT 3

### NiO—CuO Catalyst

Nickel oxide (Nio) powder and copper oxide (CuO) powder are mixed by a weight ratio of 7:3 in the drum mixer for three hours. The mixed powder of 10 g is put in an alumina container and then heated in the atmosphere at a temperature of 1,000° C. in the box-type electric furnace for two hours. Then, the sintered mixture is cooled in the furnace. The sintered mixture is taken out from the electric furnace and powdered by an average micron meter of 100 or below.

This powder of 0.3 g is put in the alumina boat, and then put in the pipe-type furnace mounted with the quartz tube having a diameter of 60 mm. Then, the powder of 0.3 g is heated in the nitrogen ambient at a temperature of 550° C., is treated with reduction and carbon depositing reaction for 40 minutes in the state that nitrogen is substituted by mixed gas of 1 l/min hydrogen and 0.2 l/min acetylene, and is cooled to have a normal room temperature in the state that the mixed gas is substituted by nitrogen. After the cooling operation, a black material looking like the deposited carbon is observed by the transmission electron microscope. In result, a carbon nanofiber of a solid shape having an average diameter of 200 nm is observed.

### COMPARATIVE EMBODIMENT 1

### Fe₂O₃—Al₂O₃ Catalyst

Hematite (Fe₂O₃) powder and alumina (Al₂O₃) powder are mixed by a weight ratio of 1:1 in the drum mixer for three hours. The mixed powder of 0.3 g is put in an alumina boat, and then put in the pipe-type furnace mounted with the quartz tube having a diameter of 60 mm. Then, the powder of 0.3 g is heated in a nitrogen ambient at a temperature of 650° C., is treated with reduction and carbon depositing reaction for 40 minutes in the state that nitrogen is substituted by mixed gas of 1 l/min hydrogen and 0.1 l/min ethylene, and is cooled to have a normal room temperature in the state that the mixed gas is substituted by nitrogen. After the cooling operation, the carbon nanotube or the carbon nonofiber is not observed. The reason why the carbon nanotube or the carbon nanofiber is not observed is that the transition metal and the support material are not heated in the oxidative ambient and therefore are not formatively mixed.

### COMPARATIVE EMBODIMENT 2

### Ni—CuO Catalyst

Nickel powder and copper oxide (CuO) powder are mixed by a weight ratio of 7:3 in the drum mixer for three hours. The mixed powder of 0.3 g is put in the alumina boat, and then put in the pipe-type furnace mounted with the quartz tube having a diameter of 60 mm. Then, the powder of 0.3 g is heated in the nitrogen ambient at a temperature of 550° C., is treated with reduction and carbon depositing reaction for 40 minutes in the state that nitrogen is substituted by mixed gas of 1 l/min hydrogen and 0.2 l/min acetylene, and is cooled to have a normal room temperature in the state that the mixed gas is substituted by nitrogen. After the cooling operation, the carbon nanofiber or the carbon nanotube is not observed. The reason why the carbon nanofiber or the carbon nanotube is not observed is that two catalyst materials are not heated in the oxidative ambient and therefore are not formatively mixed.

As described above, the present invention provides a catalyst for carbon nanowires, and a method of making the same, in which a catalyst for a massive and inexpensive carbon nanowires can be simply and inexpensively made.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A method of making a catalyst for carbon nanotubes and nanofibers, comprising:
heating oxygen compound of transition metal in oxidative ambient at a temperature of 800° C. through 1,500° C. to be transformed into an agglomerated transition metal oxide; and
powdering the agglomerated transition metal oxide into a minute particle.

2. The method according to claim 1, wherein the transition metal includes one or more selected from a group consisting of nickel (Ni), cobalt (Co), iron (Fe), molybdenum (Mo), and chrome (Cr).

3. The method according to claim 1, wherein the oxidation compound of the transition metal includes one or more selected from a group consisting of transition metal oxide, hydroxide, carbide, sulfide and nitride.

4. The method according to claim 1, wherein the agglomerated transition metal oxide is powdered to have an average particle size of 500, um or below.

5. The method according to claim 1, wherein the oxygen compound of the transition metal includes oxygen compound of copper.

6. The method according to claim 5, wherein the oxygen compound of copper ranges from 10% to 50% weight with regard to 100% weight of the transition metal oxide.

7. The method according to claim 6, wherein the oxygen compound of the transition metal is heated at a temperature of 800° C. through 1,000° C.

8. The method according to claim 1, wherein the oxygen compound of the transition metal is heated together with a support material selected from a group consisting of silica, alumina and magnesia.

9. The method according to claim 8, wherein the oxygen compound of the transition metal is heated at a temperature of 1,000° C. through 1, 400° C.

10. A catalyst for carbon nanotubes and nanofibers, which has an average particle size of 500 um or below and in which transition metal oxide and copper oxide are sintered.

11. A catalyst for carbon nanotubes and nanofibers, which has an average particle size of 500, um or below and in which transition metal oxide and a support material selected from a group consisting of silica, alumina and magnesia are sintered.

12. The catalyst according to claim 10, wherein the transition metal includes one or more selected from a group consisting of nickel (Ni), cobalt (Co), iron (Fe), molybdenum (Mo), and chrome (Cr).

13. The catalyst according to claim 11, wherein the transition metal includes one or more selected from a group consisting of nickel (Ni), cobalt (Co), iron (Fe), molybdenum (Mo), and chrome (Cr).
